(19) United States
(12) Patent Application Publication
(10) Pub. No.: US 2025/0386188 A1
(43) Pub. Date: Dec. 18, 2025

(54) SIMPLIFIED ZERO TOUCH PROVISIONING

(71) Applicant: HEWLETT PACKARD ENTERPRISE DEVELOPMENT LP, Spring, TX (US)

(72) Inventors: Pierre-Yves Descombes, Annecy-le-vieux (FR); Madhushree Gubbi Chikkanna, Bangalore (IN); Makoto Gozu, Tokyo (JP); Vijaya Bhimrao Nadgir, Bangalore (IN)

(21) Appl. No.: 18/899,113

(22) Filed: Sep. 27, 2024

(30) Foreign Application Priority Data
Jun. 12, 2024 (EP) 24305926.8

(51) Int. Cl. H04W 12/06; H04W 12/72

(52) U.S. Cl. CPC H04W 12/06; H04W 12/72

(57) ABSTRACT

Systems and methods are provided for bootstrapping Internet of Things (IoT) device provisioning from the authentication of a IoT device's subscriber identity module (SIM). In other words, IoT device provisioning can piggyback off of SIM authentication resulting in true zero touch provisioning, where no “manual” or third party intervention is needed. In particular, an IoT device may include the SIM, communications componentry, and the functional IoT componentry (e.g., IoT sensors). While traditional attempts at zero touch provisioning fail to account for these different aspects of an IoT device, the proposed bootstrapping allows for each aspect of the IoT device to be provisioned beginning with/deriving from the authentication of the IoT device's SIM.

### BACKGROUND

Zero Touch Provisioning (ZTP) can refer to a process of remotely provisioning or configuring a network device without having to manually program the network device. For example, using ZTP, a network device that is newly-delivered to an installation site or is as-of-yet unconfigured may automatically load deployment files (provisioning/configuration/software patch files) without a need for manual intervention by an administrator or other user.

### BRIEF DESCRIPTION OF THE DRAWINGS

The present disclosure, in accordance with one or more various examples, is described in detail with reference to the following figures. The figures are provided for purposes of illustration only and merely depict typical, non-limiting aspects of such examples.

FIG. 1 illustrates an example IoT device to be provisioned in accordance with examples of the disclosed technology.

FIG. 2 illustrates an example system in which a generic bootstrapping architecture (GBA) is utilized, and operative changes to the example system in accordance with examples of the disclosed technology.

FIG. 3 an example system, with additional detail, for effectuating simplified ZTP in accordance with examples of the disclosed technology.

FIG. 4A is an example computing component that may execute instructions to achieve ZTP-GBA software functionality in accordance with examples of the disclosed technology.

FIG. 4B is a table setting forth example identifiers and keys that can be derived/calculated in accordance with examples of the disclosed technology.

FIG. 5 is an example computing component that may execute instructions to achieve ZTP-lightweight machine-to-machine (LwM2M) software functionality in accordance with examples of the disclosed technology.

FIG. 6 is an example computing component that may execute instructions to achieve ZTP-GBA device agent functionality in accordance with examples of the disclosed technology

FIG. 7 is an example computing component that may be used to implement various features of examples of the disclosed technology.

The figures are not exhaustive and do not limit the present disclosure to the precise form disclosed.

### DETAILED DESCRIPTION

Provisioning, in general, can refer to evolving a device to a state where it can be provided to an end-user or entity to be used for some particular function, e.g., getting a device configured in or on a network so that the device can operate on that network, whether it be engaging in communications, sending or receiving data, etc. More particularly, device provisioning occurs when a new/unconfigured device is first enrolled or activated on a system. Upon enrollment or activation, an identity is installed, e.g., the device may be registered to the network using some certificate along with an identifier. As an example, a network service may provide a device certificate and private key to the device, typically, over a secure connection. The device may respond with some unique token or embedded hardware secret with a provisioning request that the service can use to verify the device against an allow list. The service and device may then commence with sending and receiving, respectively, configuration files or information. The device can apply the configuration, and can connect to the network with its device certificate, private key, and configuration.

Removing the manual intervention aspect to general provisioning, ZTP may be used for the provisioning of various network devices, e.g., access points (APs), routers, etc., resulting in reduced downtime, reduced labor/resource consumption, and reduced provisioning errors due to “human” error. ZTP is particularly pertinent for large or massive Internet of Things (IOT) deployments, e.g., smart metering, where the number of IoT devices in a deployment can reach upwards of a million or more IoT devices.

However, challenges arise when applying conventional ZTP techniques to the IoT context. IoT devices typically comprise three different aspects or types of componentry, each of which have their own distinct provisioning/configuration paths, i.e., a subscriber identity module (SIM) card or a digital version thereof (eSIM), a communications component, e.g., cellular communications componentry (radio frequency (RF) radio, antenna, etc.), and the functional IoT componentry (e.g., the sensor(s)) itself. It should be noted that various types of SIMs exist, and examples of the disclosed technology can be applied to any such subscriber identity component, e.g., a universal SIM (USIM). Additionally, IoT devices are typically not associated with any end users that can assist with the provisioning of such IoT devices. That is, IoT devices can be deployed in remote locations or may not be readily accessible. Further still, IoT protocols associated with the communication/use of IoT devices involve the use of keys and user certificates, the exchange of which can depend on the provisioning of credentials that are signed/managed by third parties. Management is usually effectuated using a public key infrastructure (PKI), which involves certifications, e.g., from third parties, such as registration authorities. Thus, in the IoT context, ZTP is not necessarily free of manual intervention.

Accordingly, various examples of the disclosed technology are directed to piggybacking off of SIM authentication to achieve ZTP for IoT devices. That is, the provisioning of an IoT device's communication componentry and the functional IoT componentry are bootstrapped to SIM authentication, wherein certain logic/software may be added to an existing generic bootstrapping architecture (GBA) to allow for each aspect of an IoT device to be provisioned beginning with/deriving from SIM authentication. The Third Generation Partnership Project (3GPP) Generic Authentication Architecture (GAA), which encompasses GBA, provides mechanisms/functions whereby user equipment, such as an IoT device, can authenticate with an operator's network to securely access or interact with application services, such as a smart metering application. Authentication, as noted above, can involve the use of keys/certificates, in this case, symmetric cryptography where secret key material is known to both the user equipment and its home subscriber server (HSS). The GBA, based on 3GPP subscription credentials, provides the mechanism to authenticate and setup a security association between the user equipment and the application server(s) using hypertext transfer protocol (HTTP) Authentication and Key Agreement (AKA) authentication and key agreement.

To the above, a GBA server can provide application-independent functions for mutual authentication of user equipment and servers that may not be known to one another, and for exchanging secret keys. In some examples of the disclosed technology, software, referred to herein as ZTP-GBA software, may be added to the GBA server, where use of this ZTP-GBA software can engage a ZTP process during a SIM authentication session. That is, the ZTP-GBA software may initiate the bootstrapping from authentication of the IoT device's SIM. Identifying information can be derived from the authentication of the IoT device's SIM, as well as a pre-shared key (PSK), and the uniform resource locator (URL) of an IoT device management server in which the IoT device is to be provisioned. In a conventional GBA, a Network Application Function (NAF) comprises the authentication function of a web service, and communicates with the Bootstrapping Server Function (BSF), which authenticates a subscriber with the 3GPP subscription using the 3GPP AKA protocol. The NAF communicates with the BSF to obtain a NAF-specific shared key material for the IoT device being authenticated. It should be noted that in accordance with examples of the disclosed technology, however, the ZTP-GBA software may act, from a GBA standpoint, as the NAF.

Software, referred to herein, as ZTP-Lightweight machine-to-machine (LwM2M) (ZTP-LwM2M) software, may also be added to the IoT device management server to allow the IoT device management server to provide its URL to the ZTP-GBA software implemented in the GBA server. Moreover, the ZTP-LwM2M software can function to provision the IoT device in the IoT device management server based on the derived IoT device identifying information and PSK. A GBA application programming interface (API) may also be added to the IoT device management server to bootstrap the IoT device from the operation of the ZTP-GBA software, where such bootstrapping may be performed immediately. It should be noted that LwM2M refers to an Open Mobile Alliance (OMA) protocol that can be used for machine-to-machine or IoT device management and service enablement, its development being designed to reduce power and data usage for low-power devices, such as IoT devices. In particular, the LwM2M standard defines the application layer communication protocol between the IoT device management server, also referred to as an LwM2M server, and a Lwm2M client resident within an IoT device, also referred to as a LwM2M device. M2M can refer to the connecting of devices and applications, and IoT is a collation of M2M connections and devices.

Further still, a ZTP-GBA device agent, implemented at the IoT device, may provision the IoT device using the IoT device identifying information (which in some examples may be a LwM2M device ID), the LwM2M server URL, and the PSK. Thereafter, the ZTP-GBA device agent may force a restart of the IoT device, allowing the IoT device to perform a new attachment to the network on which it is installed, and register with the IoT device management (LwM2M) server.

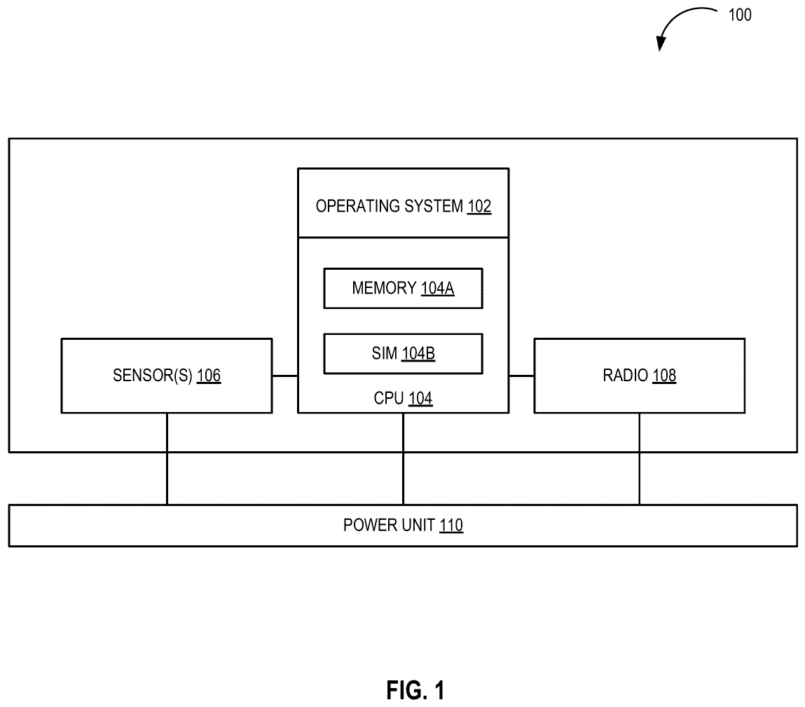

FIG. 1 illustrates an example schematic representation of an IoT device 100 to be provisioned in accordance with examples of the disclosed technology. Typically, an IoT device, such as IoT device 100, may comprise an operating system (OS) 102, a central processing unit (CPU), memory 104A, a SIM 104B, one or more sensors, e.g., sensor(s) 106, and at least one radio 108. CPU 104, sensor(s) 106, and radio 108 may be powered by a power unit 110.

CPU 104 typically comprises a primitive CPU and memory 104B for processing and storage tasks. Because the majority of IoT devices are resource-constrained, battery-operated, and small in size, high-compute CPUs and extensive memory are usually not needed. That said, there are various techniques, sensors, and firmware (that can act as an IoT device's OS). For example, sensor(s) 106 can be used to collect, e.g., real-time data from a surrounding environment, such as temperature, humidity, motion, etc., where the end device (a web-enabled hardware device that serves as either the source/destination of data) can be smart (e.g., smartphone) or more basic (e.g., RFID tag). When an IoT device is battery operated, power unit 110 may be a battery. However, an IoT device may be powered by the end device, which can also be battery-powered, but may be some other power source, e.g., mains power. Connectivity to other IoT devices, or to the cloud/other network can be effectuated via radio 108 which can comprise a variety of radio communications technologies, e.g., Wi-Fi, Bluetooth, Z-wave, Zigbee, cellular, etc.

As noted above, examples of the disclosed technology can achieve true ZTP by bootstrapping authentication of an IoT device's communication componentry and the functional IoT componentry to the authentication of that IoT device's SIM, e.g., SIM 104B of IoT device 100. An IoT or M2M SIM, such as SIM 104B, may comprise a physical SIM card removably connected to an IoT device, or an eSIM component, which may be a non-removable chip embedded in the IoT device. IoT/M2M SIMs can be considered a variation of a traditional SIM card used in mobile devices, such as smartphones, and function to establish a connection to a host network, facilitating the transfer of data to/from the IoT device. Typically, compared to traditional SIM cards, IoT/M2M SIMs are more durable (IoT devices can be installed in harsh environments), and involve greater security (the data exchanged may be sensitive data/can originate from heavily-secured sources).

While examples of the disclosed technology are described in the context of IoT device provisioning, the disclosed technology is not necessarily limited to IoT device provisioning. As noted above, use of a GBA and the LwM2M protocol, along with augmenting the GBA and use/operation of the LwM2M standard, can apply to other devices or objects. For example, other resource-constrained devices, not only IoT devices, may be provisioned in accordance with the disclosed technology. Even non-resource-constrained devices may be provisioned using and augmenting similar mechanisms, protocols, etc.

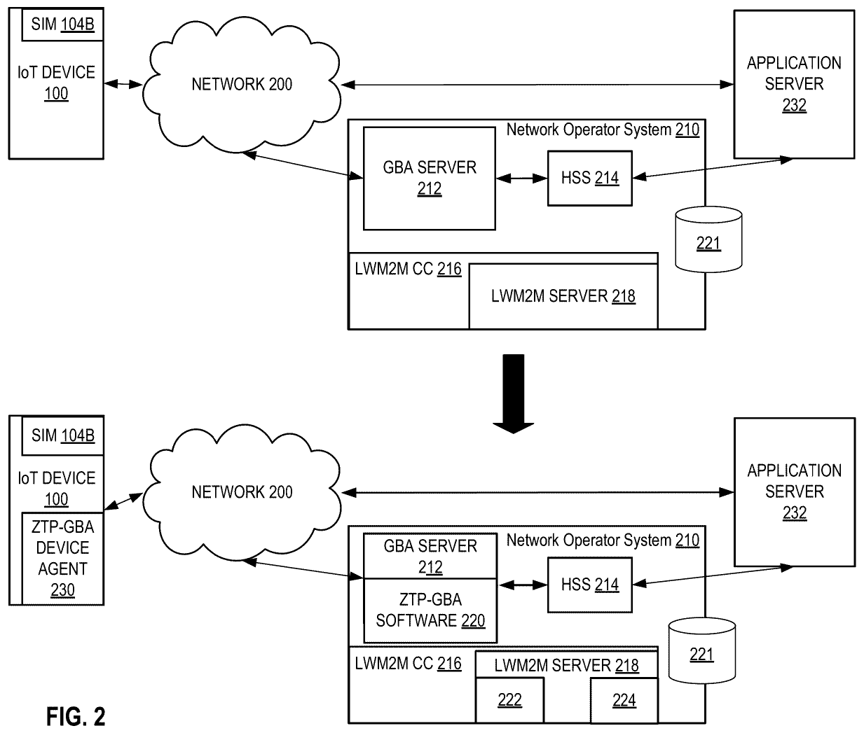

FIG. 2 illustrates an example of a conventional GBA and the functionality added to such a conventional GBA in accordance with the disclosed technology. According to GBA, authentication can be instantiated by a shared secret, one in/associated with a SIM, in this example, SIM 104B of IoT device 100, and the other in/associated with the HSS, in this example, HSS 214. HSS 214 refers to the main subscriber database used with the IP Multimedia Subsystem, and provides subscriber details to other entities within the network, e.g., network 200.

As illustrated in FIG. 2, HSS 214, along with GBA server 212 and LwM2M communications center 216 (which includes LwM2M server 218) fall under a network operator system 210. That is, network 200 may be provided to users/operated by and maintained by a network operator and that network operator's system, i.e., system 210.

As noted above, GBA server 212 is a server that can provide application-independent functions for mutual authentication of user equipment (e.g., IoT device 100), and servers that may not be known to one another (e.g., LwM2M server 218), and for exchanging secret keys. In particular, GBA server 212 may embody the aforementioned BSF that creates a security association for IoT device 100 and the Application server 232.

Application servers, such as application server 232, refer to servers that host applications or software that deliver some application, e.g., a business application through a communication protocol. NAF in this context, can refer to a particular application server that is able to use shared keys produced by GAA to authenticate subscribers.

LwM2M communications center 216 is a communications component or network element that may be provided to support LwM2M communications over a network, e.g., a cellular network, especially for large/massive IoT deployments, such as smart metering deployments. LwM2M communications center 216 supports data collection via processing the LwM2M register, uplink and downlink payload processing, providing notifications, as well as secure device-to-server communications using, e.g., Datagram Transport Layer Security (DTLS). LwM2M communications center 216 further supports device management, e.g., device onboarding, device capability mapping to LwM2M standard objects, provisioning, etc. LwM2M communications center 216 may also support user management functions, e.g., provisioning users per role-based access control, and provisioning IoT application access to resources.

Embedded in LwM2M communications center 216 is a LwM2M server, e.g., LwM2M server 218. As discussed above, LwM2M server 218 may operate to effectuate IoT device management, e.g., bootstrapping, registration, access control, configuration, service enablement, IoT device monitoring, and so on. That is, the LwM2M protocol provides IoT device management via client-server application layer communication, with LwM2M server 218 being the server-side, and IoT device 100 being the client-side. Moreover, LwM2M server 218 integrates a complete IoT object library. LwM2M objects are functionalities that the LwM2M client 231 of IoT device 100 provides. That is, IoT device 100 contains object instances which equates to a collection of resources (single items of data) exposed by IoT device 100 for consumption by an application, e.g., an application of application server 232.

As noted above, examples of the disclosed technology augment conventional GBA with software, e.g., ZTP-GBA software 220 added to GBA server 212, and ZTP-LwM2M software 222 added to LwM2M server 218. Additionally, a ZTP-GBA device agent 230 is added to IoT device 100. Again, ZTP-GBA software 220 may be used to initiate the bootstrapping from authentication of SIM 104B. Identifying information can be derived from the authentication of SIM 104B, as well as a PSK, and the URL of LwM2M server 218 in which IoT device 100 is to be provisioned. ZTP-LwM2M software 222 allows LwM2M server 218 to provide its URL to ZTP-GBA software 220 of GBA server 212. ZTP-LwM2M software 222 further allows for the provisioning of IoT device 100 in Lwm2M server 218 server based on the derived IoT device 100 identifying information (e.g., LwM2M device ID) and the derived PSK. ZTP-GBA device agent 230 may provision IoT device 100 using its LwM2M device ID, LwM2M server 218's URL, and the PSK. Thereafter, ZTP-GBA device agent 230 may force a restart of IoT device 100, allowing IoT device 100 to perform a new attachment to network 200 on which it is installed, and register with LwM2M server 218.

As noted above, GBA is a key-based bootstrapping method that enables the creation of service or application keys through authentication using 3GPP subscription credentials. These credentials are typically stored on a SIM of an IoT device. Because the SIM is resident in the IoT device, the IoT device can be considered to be authenticated by virtue of the SIM. Mutual authentication between the SIM and the network on which the IoT device is deployed can result in the generation of a bootstrapping session key, Ks. Session key Ks can be used as a root key for generating application-specific session keys for GBA-enabled services, where the session key Ks may be calculated based on the SIM credential. It should be noted that no session key-related information is exposed to the network as the calculation of session key Ks is performed within/as part of the bootstrap sequence, making guessing the session key Ks an impossibility. Moreover, no outside entity has visibility regarding the calculation, again because it is performed within/as part of the bootstrap sequence which involves no outside/third party actors. As also described above, a LwM2M server integrates a standard IoT object library, where integration of a new type of IoT device becomes a seamless process. This is because the IoT objects can simply be referred to at the time of registration of the IoT device.

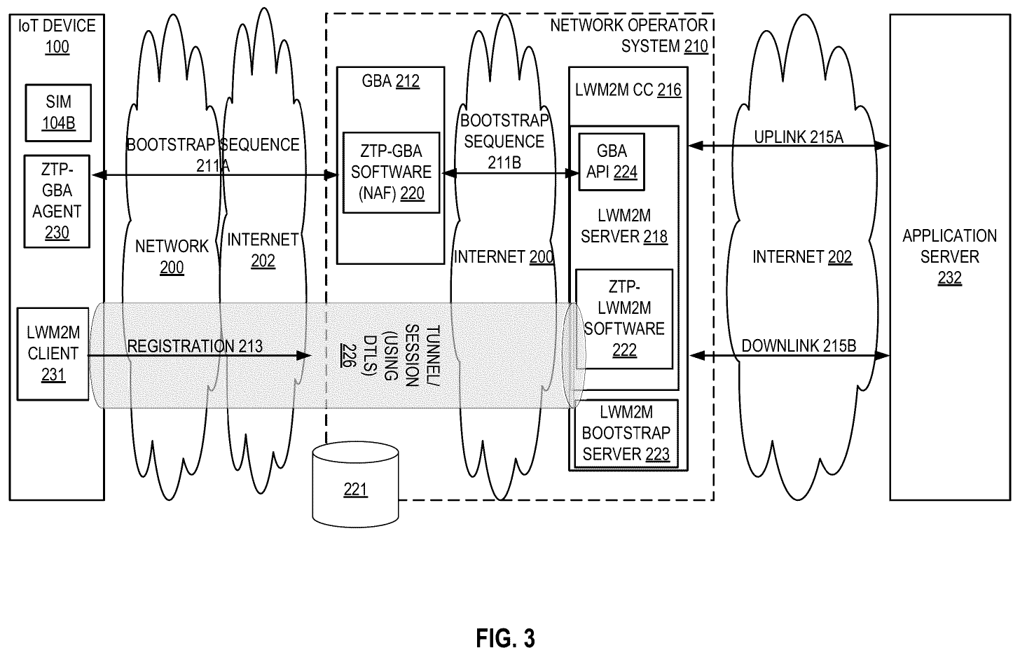

FIG. 3 illustrates a more detailed schematic representation of an improved GBA and operations performed by the improved GBA in accordance with examples of the disclosed technology. IoT device 100 may be a Lwm2M device deployed on network 200, the desired result being the ability of IoT device 100 to capture data, e.g., via its sensor componentry, and share that data via the Internet 202 to other devices, application server 232, etc. Deployment of IoT device 100 on network 200 facilitates the IoT device 200's connection to the Internet 202.

ZTP-GBA software 220, which is added to GBA 212, initiates, what can be referred to as “single shot” bootstrapping (in part, comprising bootstrap sequence 211A) from the authentication of SIM 104B which is processed by GBA 212. It should be noted that bootstrap sequence 211A can represent the initiation of the ZTP process between IoT device 100 and ZTP-GBA software 220 upon IoT device 100 starting or booting up pursuant to a power-one event, for example. Later in the ZTP process, bootstrap sequence 211A may be used by ZTP-GBA software 220 to finalize provisioning on IoT device 100 with the determined or provided LwM2M device ID, PSK, and LwM2M server URL. A self-contained definition process may be performed by extracting the International Mobile Subscriber Identity (IMSI) (or other identifying information, such as International Mobile Equipment Identity (IMEI)) from the authentication of SIM 104B. IoT device 100's IP Multimedia Private Identity (IMPI) typically used for IP Multimedia System (IMS) Voice over LTE authentication, and device ID (i.e., a LwM2M device ID) are derived from the IMSI. That is, IoT device 100 can be “defined” by the IMPI/LwM2M device ID, which can be secretly shared with ZTP-LwM2M software 222.

GBA 212 may calculate a pre-shared key (PSK), and ZTP-LwM2M software 222 (added to LwM2M communications center 216) may be updated with the PSK and the LwM2M device ID using GBA API 224 of the LwM2M server 218. GBA API 224 may further collect the LwM2M URL associated with LwM2M server 218 from ZTP-LwM2M software 222. These exchanges may make up bootstrap sequence 211B. Bootstrap sequence 211B can encompass the provisioning of Lwm2M server 218 with the LwM2M device ID and PSK (determined by ZTP-GBA software 220 via interactions between ZTP-GBA software 220 and ZTP-LwM2M software 222. Bootstrap sequence 211B may further encompass providing the LwM2M server URL from ZTP-LwM2M software 222 to ZTP-GBA software 220, the LwM2M URL referring to the LwM2M server being provisioned with the LwM2M device ID and PSK, such as LwM2M server 218. Using secured communications, e.g., tunnel/session 226, the ZTP-GBA software can update ZTP-GBA device agent 230 with the LwM2M device ID, the LwM2M server URL, and the PSK.

In turn, ZTP-LwM2M software 222, once the LwM2M server URL is provided to ZTP-GBA software 220, may provision IoT (LwM2M) device 100 in LwM2M server 218 based on the inputs to ZTP-GBA software 220 (LwM2M device ID and PSK). Optionally, the ZTP-LwM2M software may collect details (device class, profile, etc.) of a “pending” device associated with the IMSI from an offline database, such as database 221, and provision the IoT device into the LwM2M server using the shared secret (IMPI/LwM2M device ID).

ZTP-GBA device agent 230 (implemented at IoT device 100) may provision IoT device 100 using the LwM2M device ID, the LwM2M server URL, and the PSK. Thereafter, ZTP-GBA device agent 230 may force a restart of IoT device 100, allowing IoT device 100 to perform a new attachment to the network on which it is installed, in this example, network 200, and registers with LwM2M server 218 (registration 213). LwM2M server 218 may acknowledge (ACK) the registration and use the PSK to set up secured communications tunnel/session 226 with IoT device 100, e.g., using the DTLS protocol. As noted above, LwM2M communications center 216 supports uplink and downlink payload processing (215A and 215B, respectively) as illustrated in FIG. 3.

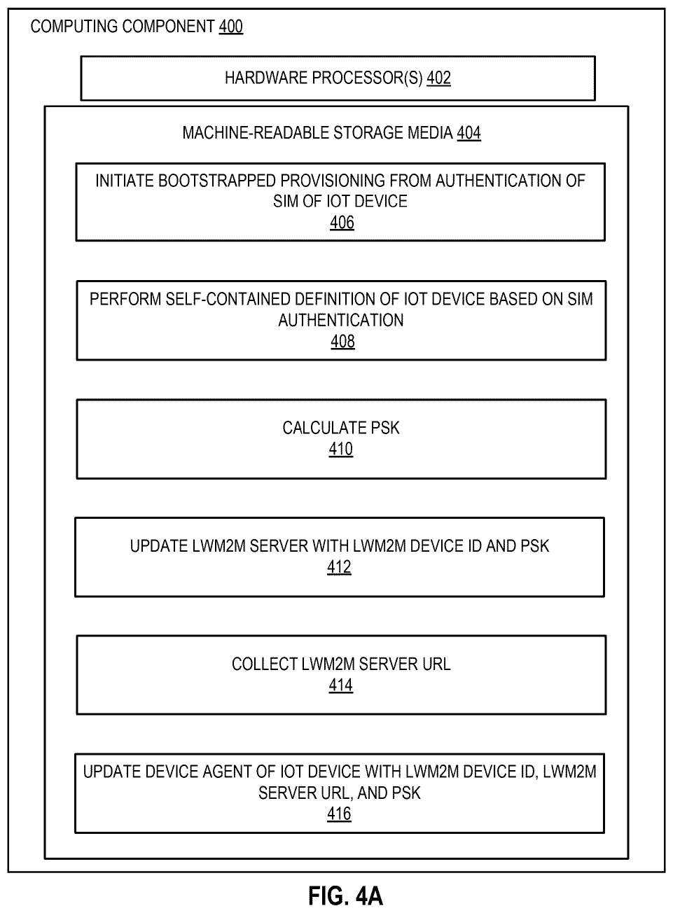

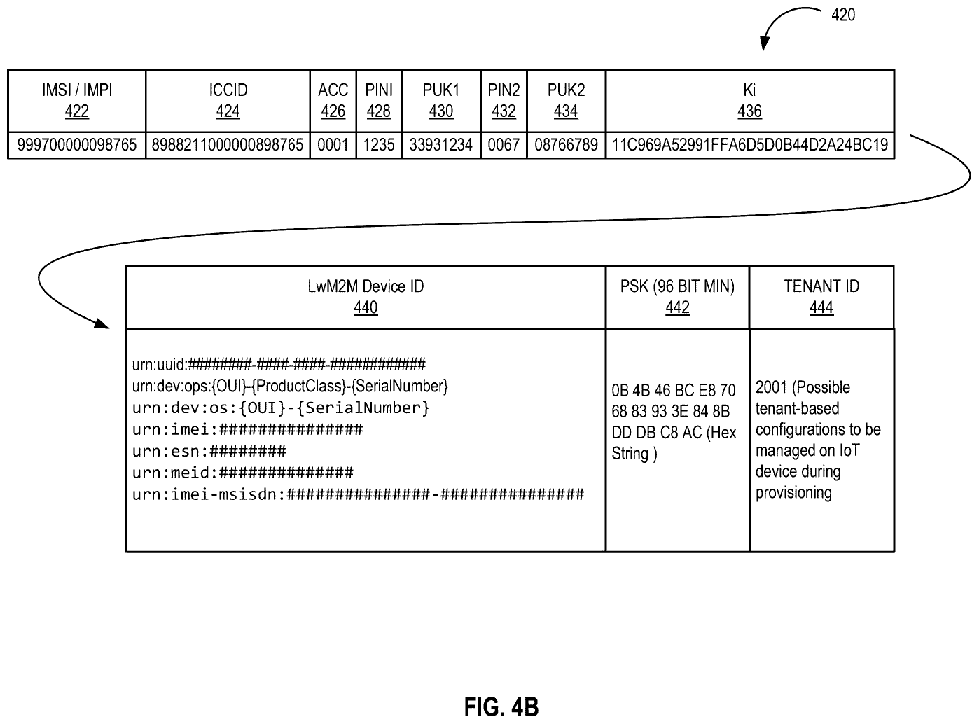

FIG. 4A illustrates a computing component that may be used to effectuate GBA server functionality for executing ZTP-GBA software in accordance with various examples of the disclosed technology. Computing component 400 may be, for example, a server computer, a controller, or any other similar computing component capable of processing data. In the example, computing component 400 includes hardware processor 402, and machine-readable storage medium 404. Computing component 400 may be an example GBA server 212.

Hardware processor 402 may be one or more central processing units (CPUs), semiconductor-based microprocessors, and/or other hardware devices suitable for retrieval and execution of instructions stored in machine-readable storage medium 404. Hardware processor 402 may fetch, decode, and execute instructions, such as instructions 406-416, to effectuate simplified ZTP from the GBA server perspective. As an alternative or in addition to retrieving and executing instructions, hardware processor 402 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 404, may be any electronic, magnetic, optical, or other physical storage device that contains or stores executable instructions. Thus, machine-readable storage medium 404 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 404 may be a non-transitory storage medium, where the term “non-transitory” does not encompass transitory propagating signals. As described in detail below, machine-readable storage medium 404 may be encoded with executable instructions, for example, instructions 406-416.

In some examples, hardware processor 402 may execute instruction 406 to initiate bootstrapping (i.e., bootstrapped provisioning of an IoT device) from authentication of a SIM of the IoT device. As discussed above, traditional ZTP techniques may only focus on one aspect of an IoT device, e.g., either the SIM, the communications componentry, or the IoT functional componentry. In contrast, examples of the disclosed technology leverage standardized GBA, SIM specifications, and the LwM2M protocol achieve ZTP of the all IoT device aspects in a single shot, and as late as a first power-up of the IoT device on a network.

To the above, IoT protocols typically use keys and user certificates for authentication or encryption, which in turn often depend on the provisioning of credentials that are signed and managed by third parties in the form of some public-key infrastructures (PKI). This means ensuring certificates are securely provisioned, updated, or revoked, which presents labor, time, and risks for large deployments over a long period of time. However, GBA, as discussed above, is a key bootstrap method standardized by the 3GPP, which enables the creation of a service or application keys through authentication using 3GPP subscription credentials. As also noted above, GBA comprises two main components in the network, the BSF, embodied by the GBA server, and the NAF, where the BSF authenticates a subscriber with the 3GPP subscription using the 3GPP AKA protocol. These 3GPP subscription credentials are typically stored on the SIM. Because the SIM is in/on the IoT device, the device can be considered to be authenticated, and mutual authentication between the SIM and network results in the generation of the Ks at both the IoT device and the GBA server. The GBA server/BSF may then provide an identifier for the Ks, a bootstrapping transaction identifier (B-TID), to the IoT device, which in turn may then use the Ks as a root key for generating any application-specific session keys for GBA-enabled services. In this way, the provisioning of the communications componentry and IoT functional componentry can be bootstrapped to the authentication of the IoT device's SIM.

Hardware processor 402 may perform self-contained definition of the IoT device based on SIM authentication. Referring to FIG. 4B, a table 420 sets forth example identifiers and keys derived/calculated in accordance with the disclosed technology. The IMSI/IMPI 422 represents a subscriber identity number that may be stored on a SIM/USIM/eSIM of the IoT device. The SIM/USIM/eSIM's primary function is to provide a mechanism by which to authenticate a use of a device, and in some examples, may also store other subscriber-related information or applications including at least one or more of the following. The IMPI is a numerical identifier by which a network can identify a subscription to the network. Typically, the IMPI contains a representation of the subscriber's IMSI. The IMPI/IMSI 422 along with related key information stored on the SIM can be used to identify and authenticate subscribers of a device in which the SIM is implemented. That key information may include the following information. An integrated circuit card identifier (ICCID) 424 is a unique serial number that is used to identify a SIM. The access control class (ACC) 426 refers to a value, typically between 0-15, used to signify an access control class of the subscriber. The SIM controls access to the network by the device, and the ACC 426 specifies parameters to control this access. A network operator may enable or set a particular access class using an ACC value. The PINx 428, 432 and PUKx 430, 434 refer to codes used to unlock the SIM, and may be pre-shared keys stored on the SIM to authenticate and being bootstrapped with the network. A subscriber key, Kᵢ, 436 corresponds to a text field containing a value that uniquely identifies the subscriber, and is typically known only to the subscriber and to an authentication entity, such as the network HSS. Subscriber keys may comprise runtime keys that can be derived after bootstrapping, which will subsequently be used for authentication.

Referring back to FIG. 4A, hardware processor 402 may execute instruction 410 to calculate the PSK. Referring again to FIG. 4B, the ZTP-GBA software, which can function as the NAF in accordance with examples of the disclosed technology, may use the subscription key and the IMPI/IMSI to derive PSK 442 (which in some examples may be a minimum of 96 bits. In some examples, the PSK 422 may be derived using a JAVA-based SecureRandom algorithm which uses SHA-1PRNG, an SHA-1 hash-based pseudo random number generator. In this example, a 16-bit IMSI/IMPI, such as IMSI/IMPI 422 can be used to generate a 128-bit PSK, such as PSK 442.

Hardware processor 402 may execute instruction 412 to update the LwM2M server with the LwM2M device ID and the PSK. In this way, the LwM2M server becomes aware of the IoT device to be provisioned. More particularly, a GBA API (such as GBA API 224) may update the GBA server with the LwM2M device ID determined through the aforementioned self-contained definition and the calculated PSK. Referring again to FIG. 4B, the LwM2M device ID 440 is the logical identification given to a device/sensor which can be derived based on the IMPI/IMSI 422. The LwM2M device ID 440 can be used to manage the device on the LwM2M server. It should be understood that a LwM2M client can refer to software on a LwM2M device that should be identified (i.e., the LwM2M device ID) on a LwM2M network. The LwM2M device ID format can be based on the type of radio/transport network used, and should be unique. A network environment in which the LwM2M protocol/standard is used may include three entities, the LwM2M client, the LwM2M bootstrap server, and the LwM2M server. The LwM2M client is located on the end user device, such as an IoT device (e.g., LwM2M client 231 of IoT device 100) and communicates with servers, such as the LwM2M server, allowing for the monitoring and management the IoT device's resources, which can be exposed via a standardized data model. The LwM2M client can be uniquely identified independent of its network address by an endpoint client name, which can be a uniform resource name (URN) that is assigned by the IoT device by, e.g., a manufacturer of the IoT device. The Open Mobile Alliance (which defines and manages resources that utilize URN naming), specifies that such an endpoint client name to be in one of the formats for the LwM2M device ID 440 set forth in table 420. The formats may include: a universally unique identifier (UUID), i.e., “urn:uuid;” an organizationally unique identifier (OUI), e.g., a multimedia access control (MAC) address including product class and serial number, i.e., “urn:dev:ops . . . ;” an OUI serial number), i.e., “urn:dev:os . . . ;” an IMEI), i.e., “urn:imei;” an electronica serial number), i.e., “urn:esn;” a mobile equipment identifier (MEID)), i.e., “urnb:meid;” or mobile station international subscriber directory number, such as standardized telephone number), i.e., “urn:imei-msisdn.” The Lwm2M bootstrap server, e.g., LwM2M bootstrap server 223, can refer to a particular server that may be contacted by a client during its first boot-up or during every boot-up operation for the purposes of initializing the data model (exposing the LwM2M client), including connections to a LwM2M server prior to contacting the LwM2M server. It should be noted that the LwM2M bootstrap server communicates with a client/IoT device using a different set of commands versus those used to communicate between the client/IoT device and a “regular” LwM2M server, such as LwM2M server 218. The LwM2M server, such as LwM2M server 218, maintains connections with the client/IoT device, and can read from/write to the data model exposed by the LwM2M client. It should be noted that any given client/IoT device can connect to more than one LwM2M server, and each LwM2M server may have access to a desired/specified portion of the exposed data model.

Moreover, tenant ID 444 identifies a network customer or tenant provisioned in the LwM2M communications center. In some examples, tenant-based configurations to be managed on the IoT device may be identified during provisioning by the tenant ID 444. The LwM2M communications center (such as Lwm2M communications center 216) may use the tenant ID 444 to create different Lwm2M device objects. Following the smart meter example presented above, a particular network customer may manage gas meters based on LwM2M standard objects while another network customer may manage devices based on Uficy standard objects.

Hardware processor 402 may execute instruction 414 to collect the LwM2M server URL. In particular, the GBA API may obtain the LwM2M server URL. Under the control of the ZTP-GBA software, the GBA API collects inputs from the BSF which can then be used to engage with the LwM2M server.

Hardware processor 402 may execute instruction 416 to update a device agent of the IoT device with the LwM2M device ID, the LwM2M server URL, and the PSK. As noted above, and as will be discussed in greater detail below, after the IoT device is restarted after provisioning, the IoT device can attach to the network and register with the LwM2M server using its self-defined parameters (the Lwm2M device ID and PSK), the identification of the LwM2M server being made possible by the GBA API-obtained LwM2M server URL. That is, the LwM2M server URL is used to allow the IoT device to execute its registration request to (and to further communicate with) the Lwm2M server. The LwM2M device ID identifies the device uniquely within the LwM2M server. The PSK is used to secure communications on both the IoT device-side, and the Lwm2M server-side. It should be understood that when the IoT device first powers up, there is not yet any LwM2M device ID, PSK, nor LwM2M server URL set forth or provisioned on the IoT device. Again, the SIM performs its authentication to the network, which triggers the ZTP-GBA software to initiate bootstrapping from the SIM authentication since the GBA is positioned in the authentication path of the SIM.

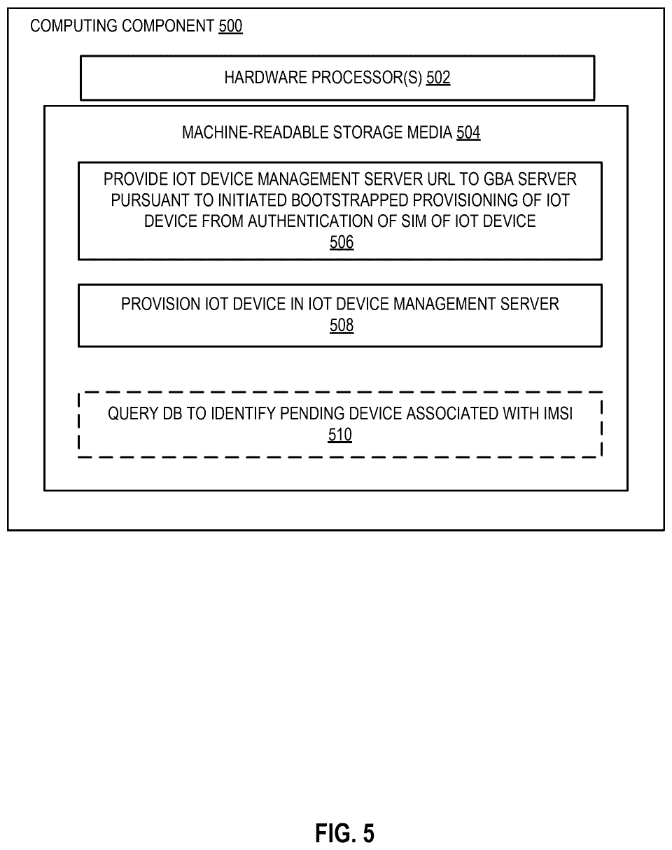

FIG. 5 illustrates a computing component that may be used to effectuate LwM2M communications center functionality by a LwM2M server for executing ZTP-Lwm2M software added to the LwM2M server in accordance with various examples of the disclosed technology. Computing component 500 may be, for example, a server computer, a controller, or any other similar computing component capable of processing data. In the example, computing component 500 includes hardware processor 502, and machine-readable storage medium 504. Computing component 500 may be an example processor(s) of LwM2M server 218.

Hardware processor 502 may be the same as/similar to hardware processor 402, already described above. Machine-readable storage medium 504 may be the same as/similar to machine-readable storage medium 404, already described above. As discussed in detail below, machine-readable storage medium 504 may be encoded with executable instructions, for example, instructions 506-510.

In some examples, hardware processor 502 may execute instruction 506 to provide the URL of the IoT device management (LwM2M) server, e.g., LwM2M server 218, to the GBA server, in particular, the ZTP-GBA software, e.g., ZTP-GBA software 220 of GBA server 212. This may be performed pursuant to the initiated bootstrapped provisioning. Providing the LwM2M server URL to the ZTP-GBA software informs the GBA/GBA protocol of the LwM2M server involved in the bootstrapped provisioning of the IoT device. The ZTP-LwM2M software, e.g., ZTP-LwM2M software 222 as noted above, can manage the ZTP of one or more LwM2M servers, such as LwM2M server 218, and the IoT device 100 itself will need to identify the proper LwM2M server with which to register/send commands to/etc. Such communications may be effectuated through the use of one or more APIs.

That is, and in some examples, hardware processor 502 may execute instruction 508 to provision the IoT device in the IoT device management (LwM2M) server. Provisioning of the IoT device may be premised on the defined LwM2M device ID and PSK associated with the IoT device, and received as inputs from the ZTP-GBA software. As noted above, such information may comprise needed parameters of the GBA API, e.g., GBA API 221. The LwM2M server URL must be known to the IoT device so that the IoT device (identified by the LwM2M device ID) can register with the proper LwM2M server, and for further communications purposes. The LwM2M device ID uniquely identifies the LwM2M client/IoT device on the LwM2M server, while the PSK is used to secure communications on both the device and server sides.

In some examples, hardware processor 502 may optionally execute instruction 510 to query a database to identify a pending device associated with the IMSI. That is, the ZTP-LwM2M software that is added to the LwM2M server may search or query some offline database using the shared secret, i.e., the LwM2M device ID and IMPI, to find an existing, pending IoT device associated with the IMSI. In this way, the ZTP-LwM2M software can potentially collect details or information associated with or otherwise characterizing the IoT device, such as device class, device profile, etc. Then, the ZTP-LwM2M software may proceed with provisioning the IoT device into the Lwm2M server. Referring back to FIGS. 2 and 3, it should be noted that the offline database can refer to some data repository that resides outside or away from the LwM2M server (e.g., database 221 outside of Lwm2M server 218). Entries to such an offline database may be created when the SIM of an IoT device, e.g., SIM 104B of IoT device 100, are initially provisioned in the HSS, e.g., HSS 214. Information regarding or otherwise characterizing IoT device 100, such as device type, device profile, communication parameters, etc. may be aggregated in the offline database when the NAF/ZTP-GBA software 220 is engaging with the LwM2M for provisioning IoT device 100. In some examples, such an offline database can be used as, e.g., a manufacturer's pre-provisioning datastore, or to provide the network with a queue of pending IoT devices to be provisioned.

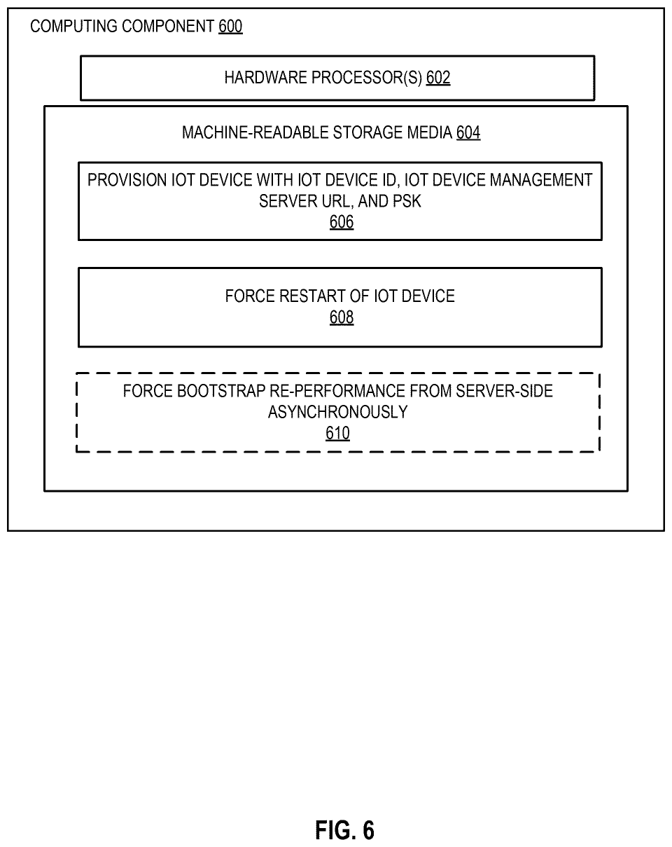

FIG. 6 illustrates a computing component that may be an example of an IoT device in which a ZTP-GBA device agent is implemented in accordance with various examples of the disclosed technology. Computing component 600 may be, for example, a controller, or any other similar computing component capable of processing data. In the example, computing component 600 includes hardware processor 602, and machine-readable storage medium 604. Computing component 600 may be an example processor(s) of IoT device 100.

Hardware processor 602 may be the same as/similar to hardware processors 402/502, already described above. Machine-readable storage medium 604 may be the same as/similar to machine-readable storage media 404/504, already described above. As discussed in detail below, machine-readable storage medium 604 may be encoded with executable instructions, for example, instructions 606-610.

In some examples, hardware processor 602 may execute instruction 606 to provision the IoT device with the IoT device ID (LwM2M device ID), the IoT device management (LwM2M) server URL, and the PSK. This allows the IoT device to eventually register with the LwM2M server identified by the LwM2M server URL.

In some examples, hardware processor 602 may execute instruction 608 to force a restart of the IoT device. Forcing a restart of the IoT device prompts the IoT device to perform a new attachment process to attach to the network, at which point, the IoT device may register with the LwM2M server using the LwM2M device ID and the LwM2M server URL. The LwM2M server, upon receiving the registration request may acknowledge the registration request. The LwM2M server may then use the defined PSK to establish a secure connection/communications with the IoT device. In some examples, (as illustrated in FIG. 3, that secure connection 226 may be effectuated using the DTLS protocol).

It should be noted that in some examples, hardware processor 602 may execute instruction 610 to force a bootstrap “redo” (re-performing bootstrapping) asynchronously from the server side. This forced bootstrap redo can be performed periodically or aperiodically to account for any PSK updates, in case the IoT device is suspected as being malicious, thereby rewriting the PSK to isolate the IoT device, etc.

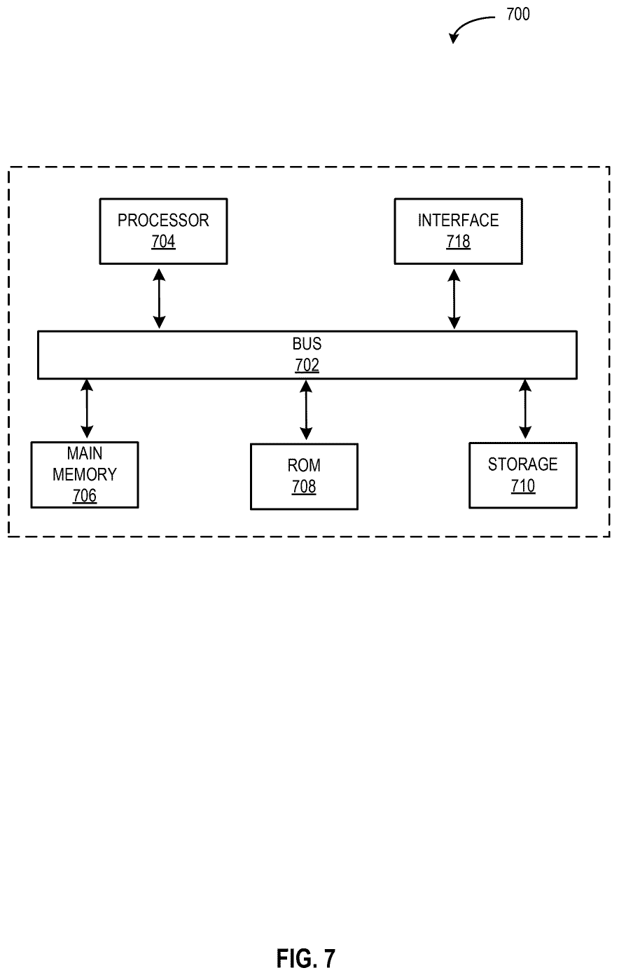

FIG. 7 depicts a block diagram of an example computer system 700 in which various examples described herein may be implemented. Computer system 700 includes bus 702 or other communication mechanism for communicating information, one or more hardware processors 704 coupled with bus 702 for processing information.

Computer system 700 also includes a main memory 706, such as a random access memory (RAM), cache and/or other dynamic storage devices, coupled to bus 702 for storing information and instructions to be executed by processor 704. Main memory 706 also may be used for storing temporary variables or other intermediate information during execution of instructions to be executed by processor 704. Such instructions, when stored in storage media accessible to processor 704, render computer system 700 into a special-purpose machine that is customized to perform the operations specified in the instructions.

Computer system 700 further includes read only memory (ROM) 706 or other static storage device coupled to bus 702 for storing static information and instructions for processor 704. Storage device 710, such as a magnetic disk, optical disk, or USB thumb drive (Flash drive), etc., is provided and coupled to bus 702 for storing information and instructions.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

Computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor(s) 704 executing one or more sequences of one or more instructions contained in main memory 706. Such instructions may be read into main memory 706 from another storage medium, such as storage device 710. Execution of the sequences of instructions contained in main memory 706 causes processor(s) 704 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Non-transitory media is distinct from but may be used in conjunction with transmission media. Transmission media participates in transferring information between non-transitory media. For example, transmission media includes coaxial cables, copper wire and fiber optics, including the wires that comprise bus 702. Transmission media can also take the form of acoustic or light waves, such as those generated during radio-wave and infra-red data communications.

Computer system 700 also includes interface 718 coupled to bus 702. Interface 718 provides a two-way data communication coupling to one or more network links that are connected to one or more local networks. For example, interface 718 may be an integrated services digital network (ISDN) card, cable modem, satellite modem, or a modem to provide a data communication connection to a corresponding type of telephone line. As another example, interface 718 may be a local area network (LAN) card to provide a data communication connection to a compatible LAN (or WAN component to communicated with a WAN). Wireless links may also be implemented. In any such implementation, interface 718 sends and receives electrical, electromagnetic or optical signals that carry digital data streams representing various types of information.

The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A system for provisioning an Internet of Things (IOT) device, comprising:
a processor; and
a memory comprising instructions that when executed, cause the processor to:
initiate bootstrapped provisioning of the IoT device from authentication of a subscriber identity module (SIM) of the IoT device;
perform self-contained definition of the IoT device based on the SIM authentication;
calculate a pre-shared key (PSK);
update an IoT device management server with an IoT device identifier and the PSK obtained from the self-contained definition of the IoT device;
collect a uniform resource locator (URL) associated with the IoT device management server; and
update a device agent of the IoT device with the IoT device identifier, the IoT device management server URL, and the PSK, thereby facilitating registration of the IoT device with the IoT device management server.

2. The system of claim 1, wherein the instructions that when executed cause the processor to perform self-contained definition of the IoT device further cause the processor to derive the IoT device identifier from an international mobile subscriber identity (IMSI) and related key information stored on the SIM.

3. The system of claim 2, wherein the derived IoT device ID comprises a lightweight machine-to-machine (LwM2M) device identifier.

4. The system of claim 2, wherein the related key information comprises at least one of a unique serial number of the SIM, access control class information, a set of PSKs stored on the SIM used for the authentication of the SIM and the bootstrapped provisioning of the ioT device, a subscriber key uniquely identifying a subscriber associated with the IoT device, and a tenant identifier.

5. The system of claim 4, wherein the processor comprises a processor of a generic bootstrapping architecture (GBA).

6. The system of claim 5, wherein the memory comprises further instructions that when executed further cause the processor to generate the PSK based on the SIM authentication at the IoT device and at a GBA server upon calculation of the PSK.

7. The system of claim 6, wherein the instructions that when executed cause the processor to calculate the pre-shared key further causes the processor to derive the pre-shared key based on hash-based pseudo random number generation using the subscriber key and the IMSI.

8. The system of claim 6, wherein the IoT device management server comprises a LwM2M server communicatively coupled to the GBA server via an Internet connection.

9. The system of claim 8, wherein the instructions that when executed cause the processor to update the LwM2M server with the Lwm2M device identifier and the PSK further cause the processor to control a GBA application programming interface (API) implemented within the LwM2M server to update zero touch provisioning (ZTP) software of the LwM2M server with the LwM2M device identifier and the PSK.

10. The system of claim 9, wherein the instructions that when executed cause the processor to collect the LwM2M server URL from the ZTP software of the LwM2M server.

11. The system of claim 1, wherein the initiated bootstrapped provisioning of the IoT device comprises initiating and performing provisioning of communications componentry of the IoT device and functional IoT componentry of the IoT device beginning with and based on the authentication of the SIM of the IoT device.

12. A system for provisioning an Internet of Things (IOT) device, comprising:
a processor; and
a memory comprising instructions that when executed, cause the processor to:
provide an IoT device management server uniform resource locator (URL) to a generic bootstrapping architecture (GBA) server pursuant to initiated bootstrapped provisioning of the IoT device from authentication of a subscriber identity module (SIM) of the IoT device; and provision the IoT device via the GBA server in the IoT device management server identified by the IoT device management server URL.

13. The system of claim 12, wherein the IoT device management server comprises a lightweight machine-to-machine (LwM2M) server.

14. The system of claim 13, wherein the instructions that when executed cause the processor to provision the IoT device in the LwM2M server further cause the processor to provision the IoT device using a defined LwM2M device identifier and a pre-shared key (PSK) derived based on self-contained defining of the IoT device pursuant to the initiated bootstrapped provisioning of the IoT device.

15. The system of claim 12, wherein the memory comprises further instructions that when executed further cause the processor to query a database to identify the IoT device with an international mobile subscriber identity (IMSI), wherein the IoT device comprises a pending device to be provisioned in the database.

16. The system of claim 15, wherein the database comprises information characterizing the IoT device, the information being created in the database upon the SIM of the IoT device being provisioned with a home subscriber server (HSS) of a network in which the IoT device is to be provisioned.

17. A system for provisioning an Internet of Things (IOT) device, comprising:
a processor; and
a memory comprising instructions that when executed, cause the processor to:
provision the IoT device with an IoT device identifier, an IoT device management server uniform resource locator (URL), and a pre-shared key (PSK); and
force a restart of the IoT device to prompt registration of the IoT device with an IoT device management server identified by the IoT device management server URL.

18. The system of claim 17, wherein the processor comprises a processor of the IoT device executing a device agent implemented on the IoT device, wherein the IoT device identifier comprises a lightweight machine-to-machine (LwM2M) device identifier, and wherein the IoT device management server comprises a LwM2M server, the LwM2M device identifier and the PSK having been derived based on self-contained defining of the IoT device pursuant to initiated bootstrapped provisioning of the IoT device from authentication of a subscriber identity module (SIM) of the IoT device.

19. The system of claim 18, wherein the instructions that when executed cause the processor to force the restart of the IoT device to prompt registration further causes the processor to register the IoT device with the LwM2M server such that the Lwm2M server establishes a secure connection with the IoT device using the PSK.

20. The system of claim 19, wherein the memory comprises further instructions that when executed further cause the processor to force re-performing a bootstrapping operation from the LwM2M server asynchronously.
